(19) United States
(12) Patent Application Publication
(10) Pub. No.: US 2017/0367924 A1
(43) Pub. Date: Dec. 28, 2017

(54) SYSTEMS AND METHODS FOR A MALE MASSAGE APPARATUS

(71) Applicant: Nanma Manufacturing Co., Ltd., Hong Kong (CN)

(72) Inventor: Simon Siu Man Nan, Richmond Hill (CA)

(21) Appl. No.: 15/195,177

(22) Filed: Jun. 28, 2016

(51) Int. Cl. A61H 19/00; A61H 23/00

(52) U.S. Cl. CPC A61H 19/32; A61H 23/00

(57) ABSTRACT

Various embodiments of a male massage apparatus having a flexible body having an exterior portion defining a textured surface and an interior portion defining an axial channel in communication with a proximal opening configured to allow passage of a male organ into the axial channel without establishing substantial contact are disclosed. The interior portion of the flexible body defines a flexible filament arrangement defining concentric rows of flexible elongated filaments that extend along the axial channel and being configured to contact the male organ when the user applies an inward pressure against the flexible body.

### FIELD

The present disclosure generally relates to massage apparatuses and in particular to a male massage apparatuses having an axial channel forming a flexible filament arrangement for providing a massage effect when the male massage apparatus is squeezed around the male organ during use.

### BACKGROUND

Massage apparatuses are well known. Typically, massage apparatuses have been designed for use for both men and women to provide tactile stimulation to the sexual organ. In particular, male massage apparatuses are designed to fit snugly around the male organ and provide a massage effect during use. However, the differences in size of various male organs, particularly those male organs having a large girth, can make certain male massage apparatuses difficult to use since the male organ may be too large to properly fit within the male massage apparatus. As such, there is a need for male massage apparatuses that can accommodate different girths of male organs while still providing an enhanced massage effect to the individual.

### BRIEF DESCRIPTION OF THE DRAWINGS

FIG. 1 is a perspective view of a first embodiment of the massage apparatus, according to aspects of the present disclosure;

FIG. 2 is a perspective view of the massage apparatus of FIG. 1 showing the axial channel with a flexible filament arrangement, according to aspects of the present disclosure;

FIG. 3 is a front view of the massage apparatus of FIG. 1, according to aspects of the present disclosure;

FIG. 4 is a cross-sectional view of the massage apparatus taken along line 4-4 of FIG. 3, according to aspects of the present disclosure;

FIG. 5 is an enlarged view of the massage apparatus of FIG. 4 showing the flexible filament arrangement, according to aspects of the present disclosure;

FIG. 6 is a top view of the massage apparatus of FIG. 1, according to aspects of the present disclosure;

FIG. 7 is a bottom view of the massage apparatus of FIG. 1, according to aspects of the present disclosure;

FIG. 8 is a partial cross-sectional view of the massage apparatus taken along line 8-8 of FIG. 1 showing the flexible filament arrangement that surrounds the axial channel, according to aspects of the present disclosure;

FIG. 9 is a bottom view of a second embodiment of the massage apparatus showing a plurality of flexible node-shaped protrusions that surround the axial channel, according to aspects of the present disclosure;

FIG. 10 is a bottom view of a third embodiment of the massage apparatus showing a plurality of flexible pin-shaped protrusions that surround the axial channel, according to aspects of the present disclosure;

FIG. 11 is a flow chart illustrating one method of using the massage apparatus of FIG. 1, according to aspects of the present disclosure;

FIG. 12 is a front view of a fourth embodiment of the massage apparatus with a vibration component, according to aspects of the present disclosure;

FIG. 13 is a perspective view of the massage apparatus of FIG. 12, according to aspects of the present disclosure;

FIG. 14 is an exploded view of the massage apparatus of FIG. 12, according to aspects of the present disclosure;

FIG. 15 is a cross-sectional view of the massage apparatus taken along line 15-15 of FIG. 12, according to aspects of the present disclosure;

FIG. 16 is a perspective view of a fifth embodiment of the massage apparatus with an open ended configuration, according to aspects of the present disclosure;

FIG. 17 is a side view of the massage apparatus of FIG. 16, according to aspects of the present disclosure;

FIG. 18 is an exploded side view of the massage apparatus of FIG. 16, according to aspects of the present disclosure; and

FIG. 19 is an exploded end view of the massage apparatus of FIG. 16 according to aspects of the present disclosure

Corresponding reference characters indicate corresponding elements among the view of the drawings. The headings used in the figures do not limit the scope of the claims.

### DETAILED DESCRIPTION

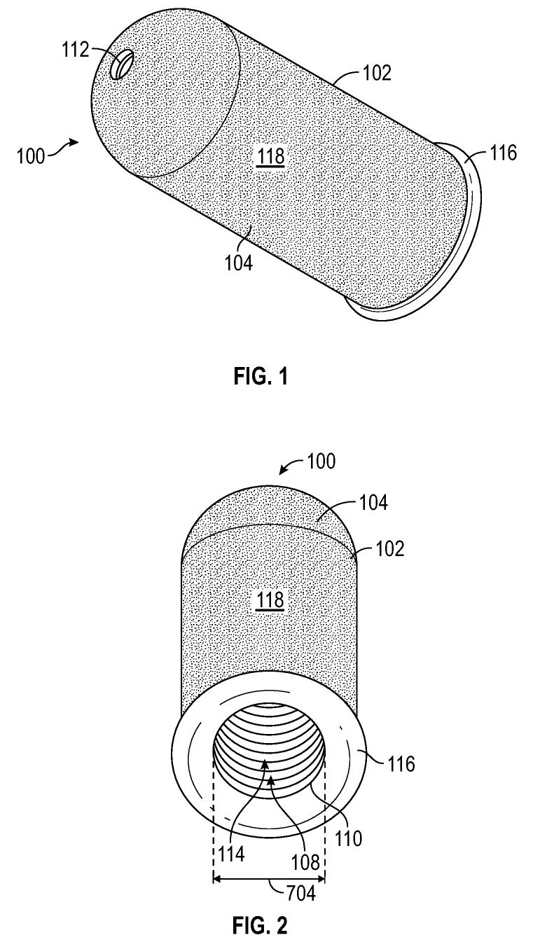

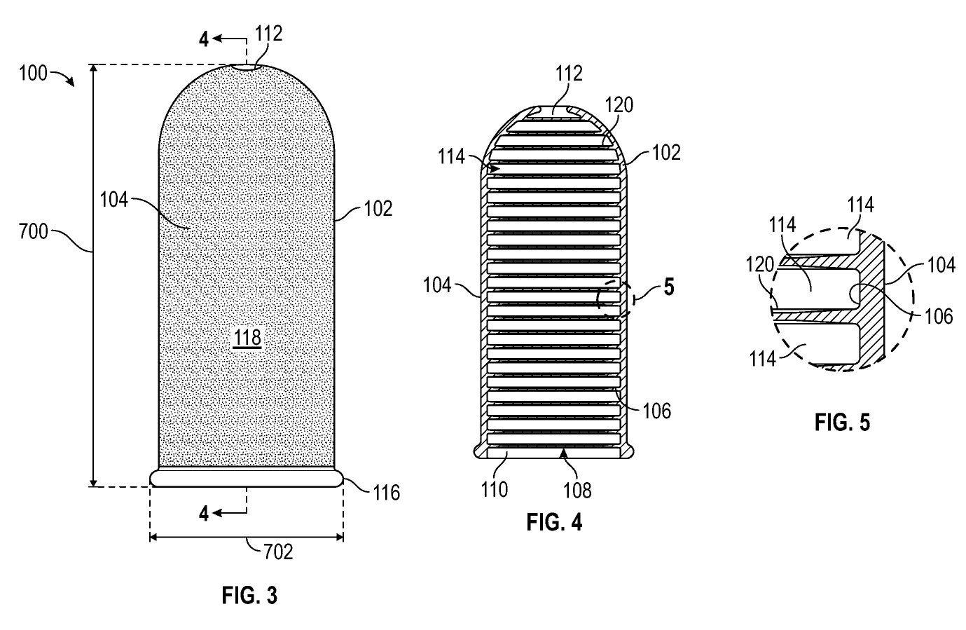

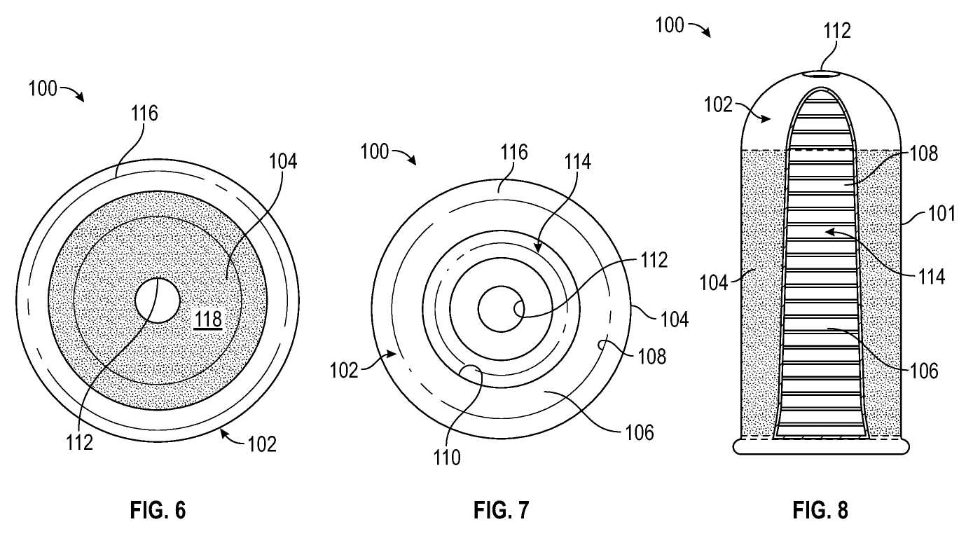

Various embodiments of a male massage apparatus having an interior axial channel defining different kinds of flexible filament arrangements to provide an enhanced massaging effect to the user are disclosed. In some embodiments, the male massage apparatus may be configured to accommodate different girths of male organs without establishing substantial contact with the male organ when the male massage apparatus is in a relaxed state. In some embodiments, the male massage apparatus may be squeezed around the male organ to provide increased tactile sensation to the user during use of the male massage apparatus. In some embodiments, the male massage apparatus may be configured to allow sperm collection through an opening formed at the far end of the apparatus. Referring to the drawings, embodiments of a male massage apparatus are illustrated and generally indicated as 100, 200, 300, 400 and 500 in FIGS. 1-19.

As shown in FIGS. 1-8, a first embodiment of the male massage apparatus, designated 100, is illustrated. The male massage apparatus 100 includes a generally cylindrically-shaped flexible body 102 defining an external portion 104 having a textured surface configured to be grasped by the user and an internal portion 106 configured to freely accommodate a male organ therein without establishing substantial contact with the male organ when the flexible body 102 is in a relaxed state and not being squeezed by the user. As shown, the internal portion 106 of the flexible body 102 forms an axial channel 108 having a near end in communication with a proximal opening 110 and an opposite far end in communication with a distal opening 112. The proximal opening 110 of the axial channel 108 is defined adjacent a flange 116 that forms the base of the male massage apparatus 100 and is configured to allow passage of different girths of male organs within the axial channel 108. In some embodiments, the distal opening 112 of the axial channel 108 is configured to permit sperm collection during use of the male massage apparatus 100 as shall be described in greater detail below.

Referring to FIGS. 2, 4, 5, 7, and 8, in some embodiments the internal portion 106 of the male massage apparatus 100 defines a flexible filament arrangement 114 that provides increased tactile stimulation to the male organ when disposed within the axial channel 108 as the user squeezes or otherwise applies an external pressure to the male massage apparatus 100 that surrounds the male organ. In some embodiments, the flexible filament arrangement 114 defines concentric rows of flexible elongated filaments 120 each having a raised elongated configuration that is concentrically arranged around the axial channel 108. As shown in FIG. 5, each concentric row of flexible elongated filaments 120 defines a respective peripheral edge 122. Referring to FIGS. 4 and 8, the concentric rows of elongated flexible filaments 120 may extend along the entire length of the axial channel 108 from the proximal opening 110 to the distal opening 112 of the flexible body 102. In some embodiments, each concentric row of the flexible elongated filament 120 may be spaced apart a predetermined distance relative to each other to form a respective concentric channel between adjacent concentric rows of flexible elongated filaments 120.

As noted above, the axial channel 108 of the male massage apparatus 100 is configured to be large enough to accommodate girths of most male organs without the male organ establishing substantial contact with the internal portion 206 when the flexible body 102 is in a relaxed state and the user is not applying an external pressure to the flexible body 102, such as when the user squeezes the flexible body 102. In particular, the axial channel 108 is sized and shaped to allow the male organ to be disposed therein without substantial contact with the internal portion 106 until the user grasps the male massage apparatus 100 and squeezes or otherwise applies external pressure to the external portion 104 of the flexible body 102 surrounding the male organ. The user applying pressure to the male massage apparatus 100 establishes substantial contact between the concentric rows of flexible filaments 120 and the male organ that generates increased tactile sensation to the user during use of the male massage apparatus 100.

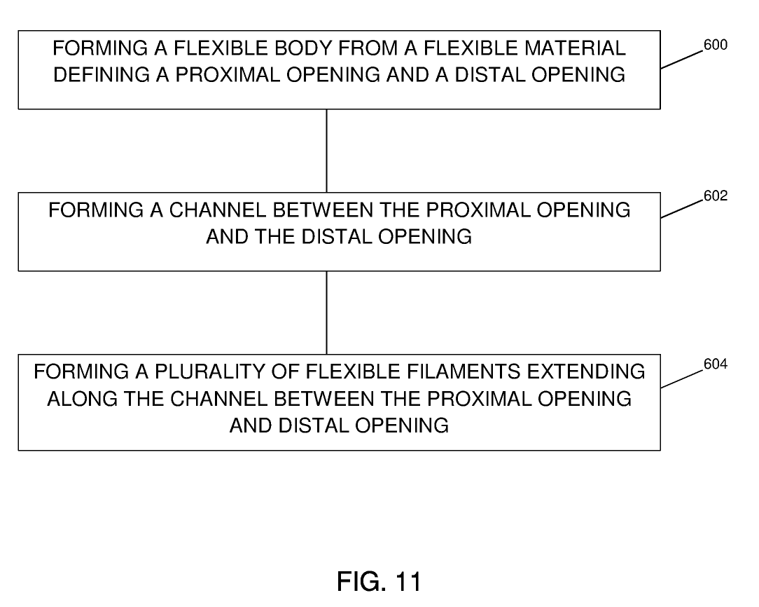

Referring to FIG. 11, a flow chart illustrates one method for manufacturing the male massage apparatus 100. At step 600, forming a flexible body 102 from a flexible material that defines a proximal opening 110 and a distal opening 112. At step 602, forming an axial channel 108 between the proximal opening 110 and the distal opening 112. At step 604 forming concentric rows of flexible elongated filaments 120 along the axial channel 108 between the proximal opening 110 and the distal opening 112 of the flexible body 102.

Referring back to FIGS. 1 and 2, in many embodiments the exterior portion 104 of the male massage apparatus 100 may define a textured surface 118 that allows the user to better grasp the flexible body 102. In some embodiments the textured surface 118 may form a plurality of small bumps that collectively form a rough surface having greater tactile feel than a smooth surface when the user grasps the male massage apparatus 100. In some embodiments, the textured surface 118 may define a plurality of raised ridges, rounded mounds, and/or symmetrical or asymmetrical protrusions that provide a tactile surface for greater gripping by the user. In some embodiments, the male massage apparatus 100 may be made from a soft silicone material that allows the flexible body 102 to be squeezed by a user.

In some embodiments the flexible body 102 may have a length 700 of about 5 inches and a width 702 of about 2.09 inches. In some embodiments, the proximal opening 110 of the channel 108 may have a preferred diameter 704 of range between 0.75 inches to 1.50 inches, although in other embodiments, the diameter 704 may be greater than 1.50 inches.

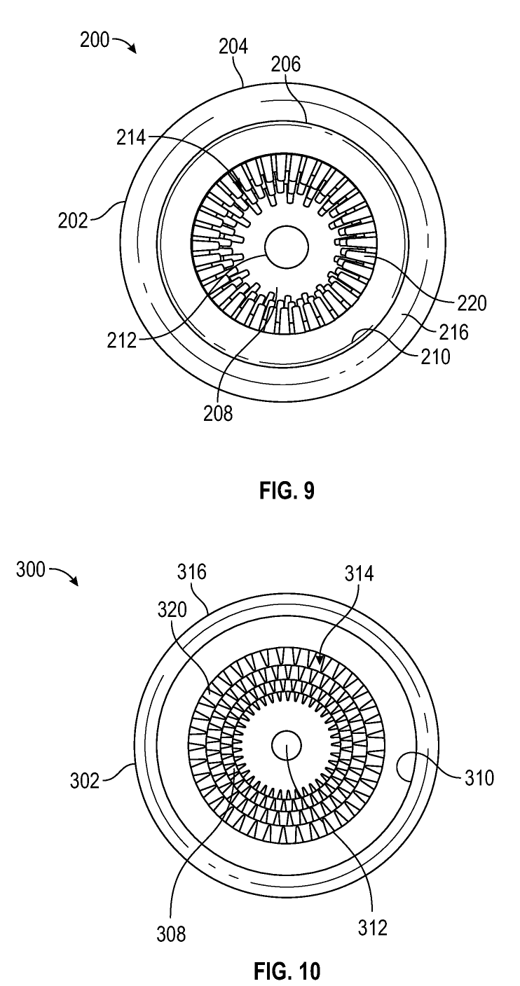

Referring to FIG. 9, a second embodiment of the massage apparatus, designated 200, is illustrated. The massage apparatus 200 is configured substantially similar to massage apparatus 100, but with a differently configured internal portion 206 to provide the massaging effect to the male organ. As shown, the male massage apparatus 200 includes a generally cylindrically-shaped flexible body 202 defining an external portion 204 having a textured surface configured to be grasped by the user and an internal portion 206 configured to accommodate a male organ therein for providing a massaging effect when the flexible body 202 is squeezed by the user. The internal portion 206 of the flexible body 202 forms an axial channel 208 having a near end in communication with a proximal opening 210 and an opposite far end in communication with a distal opening 212. The proximal opening 210 of the axial channel 208 is defined adjacent a flange 216 that forms the base of the male massage apparatus 200 and is configured to allow passage of differently sized male organs without establishing substantial contact with the internal portion 206 that forms the axial channel 208 when the flexible body 202 is not squeezed by the user. Similar to massage apparatus 100, the distal opening 212 of the axial channel 208 is also configured to permit sperm collection during use of the male massage apparatus 200.

As further shown, the internal portion 206 of the male massage apparatus 200 defines a flexible filament arrangement 214 that provides increased tactile stimulation to the male organ during the massaging effect produced by the male massage apparatus 200 as the flexible body 202 is squeezed by the user during use. In some embodiments, the flexible filament arrangement 214 defines a plurality of flexible pin-shaped protrusions 220 that surround and extend into the axial channel 208 such that contact with the male organ is achieved by the flexible pin-shaped protrusions 220 when the user squeezes the exterior portion 206 of the flexible body 202 around the male organ. In some embodiments, the flexible pin-shaped protrusions 220 may be arranged in either a symmetrical or asymmetrical arrangement around the internal portion 206 surrounding the axial channel 208. Each of the flexible pin-shaped protrusions 220 may define a needle shape configuration having a pointed free end. In some embodiments, the flexible pin-shaped protrusions 220 may be combined with the concentric rows of flexible filaments 120 of the previous embodiment. In this arrangement, the flexible pin-shaped protrusions 220 may be positioned between each concentric channel defined between respective adjacent concentric rows of flexible filaments 120.

Referring to FIG. 10, a third embodiment of the massage apparatus, designated 300, is illustrated. The massage apparatus 300 is configured substantially similar to massage apparatuses 100 and 200, but with a differently configured interior portion 306. As shown, the male massage apparatus 300 includes a generally cylindrically-shaped flexible body 302 defining an external portion 304 configured to be grasped by the user and an internal portion 306 configured to accommodate a male organ to provide a massaging effect when the flexible body 302 is squeezed by the user. The internal portion 306 of the flexible body 302 forms an axial channel 308 having a near end in communication with a proximal opening 310 and an opposite far end in communication with a distal opening 312. The proximal opening 310 of the channel 308 is defined adjacent a flange 316 that forms the base of the male massage apparatus 300 and is configured to allow passage of differently sized male organs without establishing contact with the internal portion 306 when the flexible body 302 is in a relaxed state and not squeezed by the user. Similar to massage apparatuses 100 and 200, the distal opening 312 of the axial channel 308 is also configured to permit sperm collection during use of the male massage apparatus 300.

As further shown, the internal portion 306 of the male massage apparatus 300 defines a flexible filament arrangement 314 that provides increased tactile stimulation to the male organ during the massaging effect produced by use of the male massage apparatus 300 as the flexible body 302 is squeezed by the user. In some embodiments, the flexible filament arrangement 314 defines a plurality of flexible raised node-shaped protrusions 320 each forming a raised nodal configuration having a flat free end. The flexible filament arrangement 314 is configured to surround the axial channel 308 without establishing substantial contact with the male organ unless the user squeezes the flexible body 302 to bring the flexible filament arrangement 314 in contact with the male organ disposed within the channel 308. In some embodiments, each of the plurality of flexible raised node-shaped protrusions 320 may be arranged in either symmetrically or asymmetrically around the internal portion 306 in a manner such that the user can feel increased tactile stimulation due to the substantial contact of the flexible raised node-shaped protrusions 320 with the male organ as the user squeezes the flexible body 302 of the male massage apparatus 300. In some embodiments, the plurality of flexible node-shaped protrusions 320 may be positioned along the concentric channel formed between adjacent concentric rows of flexible elongated filaments 120. In another arrangement, a combination of flexible node-shaped protrusions 320 and flexible pin-shaped protrusions 220 may be positioned along each concentric channel formed between respective adjacent concentric rows of flexible elongated filaments 120.

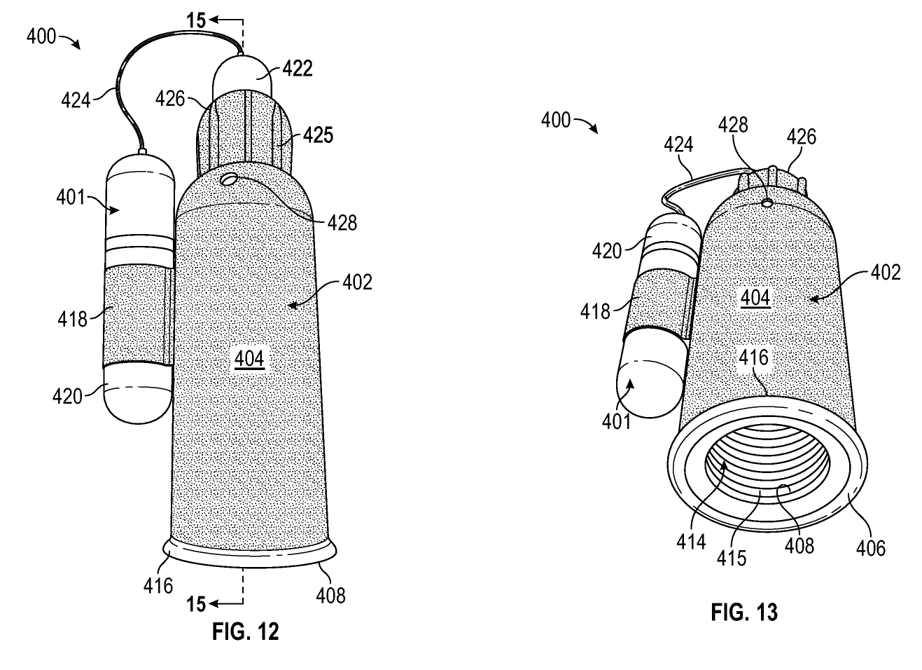

Referring to FIGS. 12-15, a fourth embodiment of the male massage apparatus, designated 400, is illustrated. The male massage apparatus 400 includes a generally cylindrically-shaped flexible body 402 defining an external portion 404 configured to be grasped by the user and an internal portion 406 configured to freely accommodate a male organ therein without establishing substantial contact with the male organ when the flexible body 402 is in a relaxed state and not being squeezed by the user. The flexible body 402 is made from a flexible material, such as a soft silicone, that provides a massaging effect when squeezed around the male organ by the user. As shown, the internal portion 406 of the flexible body 402 forms an axial channel 408 having a near end in communication with a proximal opening 410 and an opposite far end in communication with the a pair of distal openings 428 formed on opposite sides of the flexible body 402. The proximal opening 410 of the axial channel 408 is defined adjacent a flange 416 that forms the base of the male massage apparatus 400 and is configured to allow passage of differently sized male organs into the axial channel 408. In some embodiments, the pair of distal openings 428 are configured to act as a vent as well as permit sperm collection as the flexible body 402 provides a massaging effect to the male organ of the user as shall be described in greater detail below.

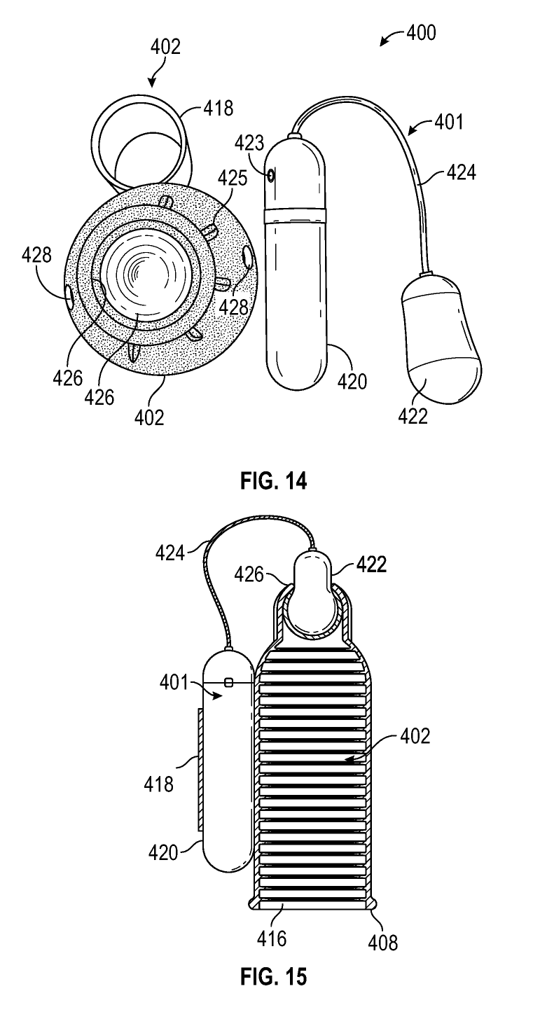

As shown, the flexible body 402 is configured to be operatively engaged to a vibrator component 401 that is operable to generate vibrations that are imparted to the flexible body 402 when an actuator button 423 on a vibrator controller 420 is actuated by the user. Referring to FIG. 14, the vibrator controller 420 is operatively connected to a vibrator 422 through a cord 424 that provides signals to the vibrator 422 to generate vibrations imparted to the flexible body 402. In some embodiments, repeated actuation of the actuator button 423 generates different kinds of vibrations by the vibrator 422. For example, initial actuation of the actuator button 423 causes the vibrator 422 to generate constant vibrations of a first magnitude, while further actuation of the actuator button 423 causes the vibrator 422 to generate constant vibrations of greater magnitude. In some embodiments, further actuation of the actuator button 423 causes the vibrator 422 to vibrate at different predetermined sequences and magnitudes.

As shown in FIGS. 15, an internal nest 426 is formed within the top portion of the flexible body 402 proximate the distal openings 428 and defines an opening in communication with an internal cavity configured to receive at least the bottom portion of the vibrator 422 therein such that vibrations are imparted from the internal nest 426 to remaining portions of the flexible body 402 during operation of the vibrator component 401. In addition, an external sleeve 418 may be formed along the side of the exterior portion 404 that is configured to receive and attach the vibrator controller 420 to the flexible body 402 to provide a convenient location to position the vibrator component 401. In some embodiments, a plurality of raised ridges 425 may be formed along the exterior portion 404 proximate the internal nest 426 as shown in FIG. 14.

In some embodiments, the axial channel 408 includes a flexible filament arrangement 414 defining concentric rows of flexible elongated filaments 415 extending along the length of the axial channel 408 between the proximal opening 410 and nest 426. The concentric rows of flexible elongated filaments 415 are made from a flexible material, such as a soft silicone material, that is configured to provide a massaging effect to the male organ when the flexible body 402 is squeezed around the male organ by the user during use of the male massage apparatus 400. In other embodiments, the axial channel 408 may also include a plurality of flexible node-shaped protrusions 320 and/or plurality of flexible pin-shaped protrusions 220 shown in the embodiments illustrated in FIGS. 9 and 10 including any combination of these protrusions 220 and 320 being positioned between one or more concentric rows of the flexible elongated filaments arrangement 415 to provide different kinds of tactile sensations to the user.

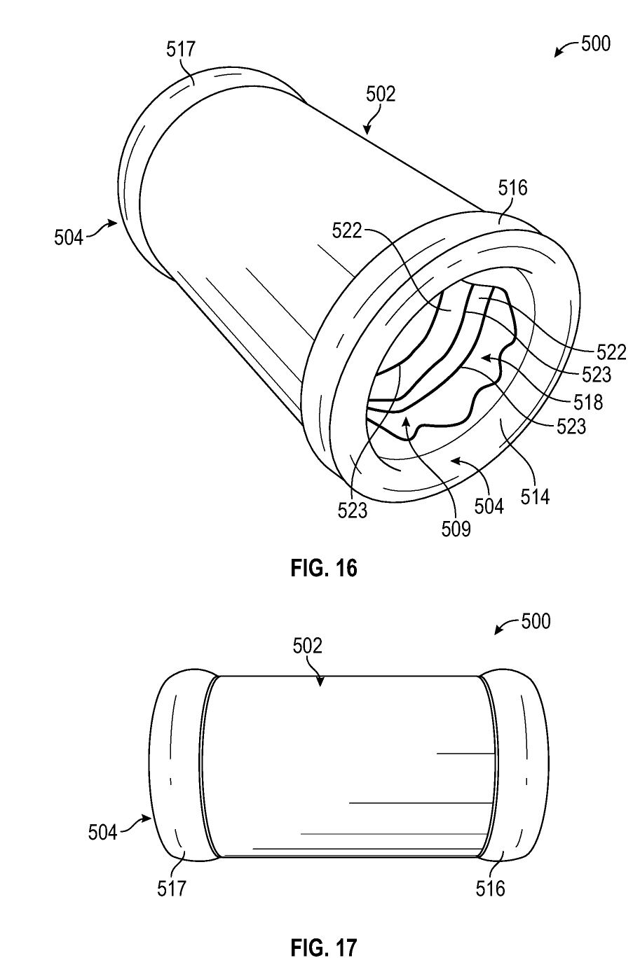

Referring to FIGS. 16-19, a fifth embodiment of the male massage apparatus, designated 500, is illustrated. The male massage apparatus 500 includes a generally cylindrically-shaped flexible shell 502 configured to receive and engage a generally cylindrically-shaped insert 504 therein as illustrated in FIGS. 16 and 17.

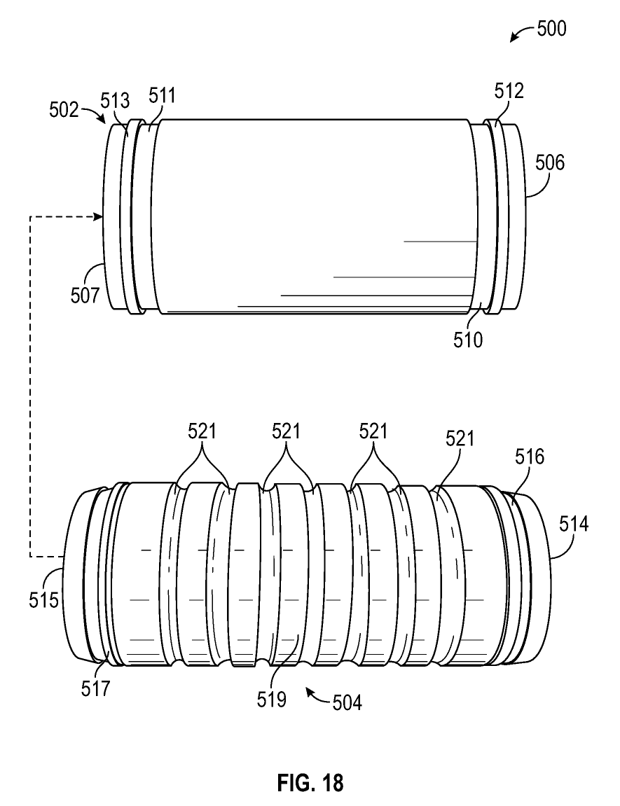

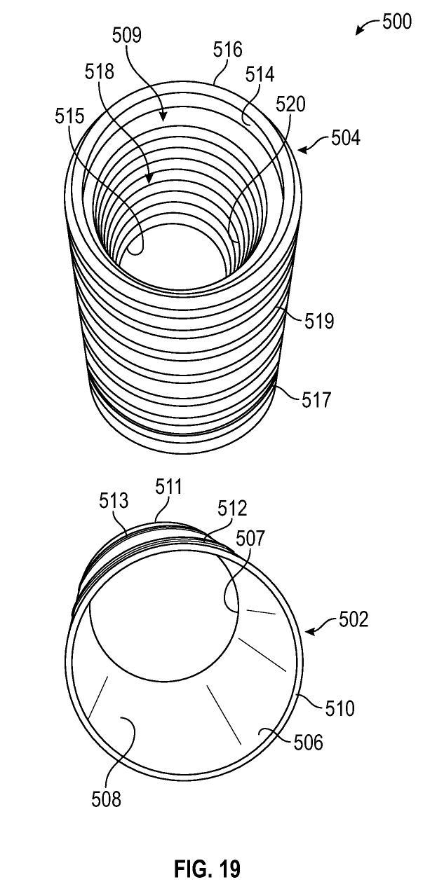

As shown in FIGS. 18 and 19, the flexible shell 502 defines an axial channel 508 that communicates with a first opening 506 at one end of the axial channel 508 and a second opening 507 at the opposite end of the channel 508. Referring specifically to FIG. 18, the flexible shell 502 defines a first flange portion 510 formed proximate the first opening 506 and a second flange portion 511 formed proximate the opposite second opening 507. As shown, the first flange portion 510 defines a circular-shaped first raised ridge 512 and the second flange portion 511 defines an identical circular-shaped second raised ridge 513 which are configured to engage respective flange portions of the flexible insert 504 when the flexible insert 504 is engaged within flexible shell 502 as shall be discussed in greater detail below.

As further shown in FIGS. 18 and 19, the flexible insert 504 defines an exterior surface 519 and an interior surface 520. The interior surface 520 of the flexible insert 504 defines an axial channel 509 that communicates with a proximal opening 514 at one end of the axial channel 509 and a distal opening 515 at the opposite end of the axial channel 509. In addition, the exterior surface 520 defines a first flange portion 516 formed proximate the proximal opening 514 and a second flange portion 517 formed proximate the distal opening 515. During manufacture of the male massage apparatus 500, the flexible insert 504 is received within the axial channel 508 of the flexible shell 502 during assembly such that the first and second flange portions 516 and 517 of the flexible insert 504 are turned inside out and contact the respective first and second flange portions 510 and 511 of the flexible shell 502 as shown in FIGS. 16 and 17. Referring to FIG. 18, the exterior surface 520 of the flexible insert 504 may define a plurality of concentric channels 521 that allow the body of the flexible insert 504 to be collapsed when being inserted into the axial channel 508 of the flexible shell 502 during assembly.

Referring to FIGS. 16 and 18, the axial channel 509 of the flexible insert 504 defines a flexible filament arrangement 518 made of a soft and flexible material, such as pliable rubber or soft silicone material, similar in configuration to the flexible filament arrangement 114 of the male massage apparatus 100. In some embodiments, the flexible filament arrangement 518 defines successive concentric rows of flexible elongated filaments 522 that extend along the channel 509 of the flexible insert 504 between the proximal opening 514 and distal opening 515. In some embodiments, each of the concentric rows of flexible filaments 522 may have an elongated raised configuration concentrically arranged around the axial channel 509. As shown in FIG. 16, each concentric row of flexible elongated filaments 522 defines a peripheral edge 523 configured to come into contact and provide a massaging effect to the male organ when the user squeezes the flexible shell 502, thereby applying an exterior pressure against the flexible insert 504 to allow the concentric rows of flexible elongated filaments 522 to contact the male organ. In other embodiments, the axial channel 509 may also include a plurality of flexible node-shaped protrusions 320 and/or a plurality of flexible pin-shaped protrusions 220 shown in the embodiments illustrated in FIGS. 9 and 10, respectively, including any combination of these protrusions 220 and 320 being positioned between adjacent concentric rows of flexible elongated filaments 522 to provide different types of tactile sensations to the user.

Similar to the above embodiments, the axial channel 509 of the flexible insert 504 is configured to freely accommodate a male organ therein without establishing substantial contact with the male organ when the flexible insert 504 is in a relaxed state and not being squeezed by the user.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A massage apparatus comprising:
a flexible body defining an external portion and an internal portion, the internal portion defining an axial channel having one end in communication with a proximal opening and an opposite end in communication with a distal opening; and
wherein the axial channel defines a flexible filament arrangement configured to establish substantial contact with a male organ disposed within the axial channel when an exterior pressure is applied against the flexible body and wherein the flexible filament arrangement is configured not to establish substantial contact with the male organ disposed within the axial channel when no outside pressure is applied to the flexible body.

2. The massage apparatus of claim 1, wherein the flexible body is made from a flexible and soft material that allows the axial channel to be compressed when the outside pressure is applied to the flexible body.

3. The massage apparatus of claim 1, wherein the flexible filament arrangement comprises concentric rows of flexible elongated filaments defining a peripheral edge.

4. The massage apparatus of claim 1, wherein the flexible filament arrangement comprises a plurality of flexible node-shaped filaments.

5. The massage apparatus of claim 1, wherein the flexible filament arrangement comprises a plurality of flexible pin-shaped filaments.

6. The massage apparatus of claim 1, wherein the flexible filament arrangement comprises concentric rows of flexible elongated filaments defining a respective concentric channel between adjacent concentric rows of flexible elongated filaments.

7. The massage apparatus of claim 6, wherein the plurality of flexible node-shaped filaments and/or the plurality of flexible pin-shaped protrusions being positioned between at least one of the concentric channels between adjacent rows of flexible elongated filaments and extending into the axial channel.

8. The massage apparatus of claim 1, wherein the proximal opening defines a diameter larger than the distal opening.

9. The massage apparatus of claim 8, wherein the proximal opening defines a diameter greater than 0.75 inches.

10. A massage apparatus comprising:
a flexible body defining an external portion and an internal portion collectively forming a top portion and a bottom portion, the internal portion defining an axial channel having one end in communication with a proximal opening formed along the bottom portion of the flexible body and an opposite end in communication with a nest formed along the top portion of the flexible body, the nest forming an internal cavity in communication with an opening formed at the top portion of the flexible body;
an external sleeve extending from the flexible body;
a flexible filament arrangement surrounding the axial channel and configured to establish substantial contact with a male organ disposed within the axial channel when an exterior pressure is applied against the flexible body; and
a vibrator component comprising a vibrator controller in operative communication with a vibrator operable to generate vibrations, the vibrator controller configured to be retained in the external sleeve and the vibrator being configured to be at least partially disposed within the internal cavity of the nest.

11. The massage apparatus of claim 10, wherein the flexible body is made from a flexible and soft material that allows the axial channel to be compressed when the outside pressure is applied to the flexible body.

12. The massage apparatus of claim 10, wherein the flexible filament arrangement comprises concentric rows of flexible elongated filaments defining a peripheral edge.

13. The massage apparatus of claim 10, wherein the flexible filament arrangement comprises a plurality of flexible node-shaped filaments.

14. The massage apparatus of claim 10, wherein the flexible filament arrangement comprises a plurality of flexible pin-shaped filaments.

15. The massage apparatus of claim 10, wherein the flexible filament arrangement comprises concentric rows of flexible elongated filaments defining a respective concentric channel between adjacent concentric rows of flexible elongated filaments.

17. The massage apparatus of claim 10, wherein the axial channel is in communication with one or more distal openings each having a respective diameter less than the diameter of the proximal opening.

18. A massage apparatus comprising:
a flexible shell defining an axial channel having one end in communication with a first opening and an opposite end in communication with a second opening, the flexible shell being made from a soft material that allows the flexible shell to be compressed when an exterior pressure is applied; and
a flexible insert disposed within the axial channel of the flexible shell, the flexible insert defining a channel having one end in communication with a proximal opening and an opposite end in communication with a distal opening, the flexible insert comprising a flexible filament arrangement surrounding the channel of the flexible insert, wherein the flexible filament arrangement is configured to establish substantial contact with a male organ disposed within the channel when an exterior pressure is applied against the flexible shell.

19. The massage apparatus of claim 18, wherein the proximal opening forms the same diameter as the distal opening.

20. The massage apparatus of claim 10, wherein the flexible filament arrangement comprises concentric rows of flexible elongated filaments defining a peripheral edge.

21. The massage apparatus of claim 18, wherein the flexible filament arrangement comprises a plurality of flexible node-shaped filaments.

22. The massage apparatus of claim 18, wherein the flexible filament arrangement comprises a plurality of flexible pin-shaped filaments.

23. The massage apparatus of claim 18, wherein the flexible filament arrangement comprises concentric rows of flexible elongated filaments defining a respective concentric channel between adjacent concentric rows of flexible elongated filaments.

24. The massage apparatus of claim 18, wherein the flexible shell further comprises a first flange portion defining a first raised ridge formed proximate the first opening and a second flange portion defining a second raised formed proximate the second opening, and wherein the flexible insert comprises a first flange portion formed proximate the distal opening and a second flange portion formed proximate the proximal opening, wherein the first and second flange portions are configured to be turned inside-out when attached to respective first and second raised ridges of the flexible shell.

25. The massage apparatus of claim 18, wherein the flexible shell has an exterior surface that forms a plurality of concentric channels.
